(19) United States
(12) Patent Application Publication
(10) Pub. No.: US 2007/0119991 A1
(43) Pub. Date: May 31, 2007

(54) Valve for a fuel injection pump

(76) Inventors: Stefan Schuerg, Ludwigsburg (DE); Wolfgang Stoecklein, Stuttgart (DE); Holger Rapp, Ditzingen (DE); Violaine Chassagnoux, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/578,506

(22) PCT Filed: Sep. 6, 2004
(86) PCT No.: PCT/DE04/01994

§ 371 Date: May 5, 2006

(30) Foreign Application Priority Data
Nov. 5, 2003 (DE) 10351680.8

(51) Int. Cl. B05B 1/30

(52) U.S. Cl. 239/584; 239/583

(57) ABSTRACT

The invention relates to a valve for a fuel injection system, having a valve seat embodied in a valve housing, and having a valve member which is movable in the valve housing and has a sealing face that when the valve is closed rests sealingly against the valve seat and when the valve is open, together with the valve seat, defines a valve gap through which fuel flows. To prevent cavitation damage, the valve member has an encompassing hollow throat, which is disposed in the flow direction immediately downstream of the sealing face and is adjoined by an encompassing cross-sectional thickening of the valve member.

The invention relates to a valve for a fuel injection system of an internal combustion engine, having the characteristics recited in the preamble to claim 1, specifically and in particular for an injector of a common rail injection system.

### PRIOR ART

Common rail injection systems have a plurality of injectors, which are supplied with fuel from a central high-pressure reservoir, known as a common rail, by a high-pressure pump under the control of an electronic engine controller, and which inject the fuel via a valve into the combustion chambers of the cylinders of the internal combustion engine. Once such valve is known, from among other sources German Patent Disclosure DE 199 40 296 A1 of the present Applicant and, depending on the valve position, serves to connect a high-pressure region of an injector of the injection system with a low-pressure region, or to disconnect them, when fuel is injected through the valve into the combustion chamber of a cylinder and when the delivery of fuel is to be interrupted, respectively.

When the fuel, with the valve open, flows at high speed through the annular conduit, whose cross section increases markedly downstream of the valve seat, that is formed between the valve seat and the sealing face, cavitation can occur in the fuel. Vapor bubbles form in the fuel in the process, if the pressure locally drops below the vapor pressure of the fuel. The next time the pressure increases, the fuel condenses in the vapor bubbles and hits at high speed against adjacent boundary faces of the annular conduit. As a result, directly downstream of the valve seat, cavitation damage can occur, causing even the valve seat itself to be attacked as the erosion progresses.

To solve this problem, it was proposed in DE 199 40 296 A1 that the cross section of the annular conduit be widened with a constant gradient, beginning at a minimal cross section in the region of the valve gap. However, it has been demonstrated that this provision does not always suffice to prevent cavitation damage reliably.

### ADVANTAGES OF THE INVENTION

By comparison, with the use of the valve of the invention, having the characteristics recited in claim 1, cavitation damage can be prevented with good success, since the fuel stream downstream of the valve seat is not deflected only simply in the axial direction. Instead, on passing through the hollow throat, it is imparted a speed component in a direction that points away from the center axis of the valve member, so that after emerging from the hollow throat, it strikes a diametrically opposed region of an inner wall of an outflow bore of the valve housing. On impact, some of the fuel stream is directed along the inner wall back in the direction of the valve gap, and as a result, immediately downstream of this gap, an eddy forms in the widened annular chamber between the hollow throat and the diametrically opposite wall region of the inner wall. As a result of this eddy, on the one hand additional fuel is introduced into the annular chamber downstream of the valve gap, so that more fuel is present there, which counteracts cavitation phenomena in the vicinity of the valve gap and as a result counteracts cavitation damage at the valve seat that is caused over the long term. On the other hand, the fuel directed back in the direction of the valve gap flows along the inner wall of the valve housing, so that additional fuel is introduced precisely into this region that is especially threatened with cavitation, and local vapor bubble formation as a consequence of a fuel pressure drop can be avoided.

The term hollow throat should be understood in the context of the present invention to mean a concave annular groove in the circumference of the valve member, while a cross-sectional thickening should be understood to mean a part of the valve member adjoining it in the flow direction whose diameter is greater than the diameter in the region of the annular groove.

Especially good eddy formation in the enlarged annular chamber downstream of the valve gap is attained, in a preferred feature of the invention, in that between the hollow throat and the cross-sectional thickening, an undercut, encompassing detachment edge is provided, at which on both sides, outer circumferential surface portions adjoining this edge of the hollow throat and of the cross-sectional thickening meet at a reflex angle.

While the outer circumferential surface portion, adjoining the edge on the side toward the cross-sectional thickening, is preferably oriented essentially parallel to a center axis of the valve member, the circumferential surface portion adjoining the edge on the side toward the hollow throat is preferably inclined counter to the flow direction at an angle of between 20° and 80°, preferably between 30° and 60°, to the center axis of the valve member, so that the two circumferential surface portions meet one another at an angle of between 200° and 260°, and preferably between 190° and 240°.

Especially simple, economical manufacture of the detachment edge is possible, in a further preferred feature of the invention, by providing that in the final machining of the valve member, its outer circumferential surface is ground down to the final diameter at least in the region of the sealing face diametrically opposite the valve seat and of the hollow throat, but not in the region of the cross-sectional thickening, so that the material left there automatically leads to the formation of the detachment edge. In this case, the cross section of the valve member tapers in the flow direction downstream of the cross-sectional thickening, but this need not necessarily be the case.

To furnish a geometry of the valve member that can be economically achieved in mass production, the concave hollow throat expediently has a radius of curvature which is preferably at least 0.2 mm and which expediently remains constant over the entire width of the hollow throat.

To promote the eddy formation, in a further advantageous feature of the invention it can also be provided that an inner wall portion, essentially diametrically opposite the hollow throat, of the outflow bore be oriented not parallel to the center axis of the valve member or to the center axis of the outflow bore, but instead for a step or chamfer to be made in this portion, which reinforces a deflection of some of the fuel stream in the direction of the valve gap.

### DRAWINGS

The invention will be described in further detail below in terms of an exemplary embodiment in conjunction with the associated drawings. Shown are:

FIG. 1, a side view of a valve member or valve bolt of a valve of the invention;

FIG. 2, an enlarged cross-sectional view of the valve in the region of the valve gap in the detail Z of FIG. 1;

FIG. 3, an enlarged detail of FIG. 2, but with a different geometry of the valve member downstream of the valve gap in terms of the flow direction;

FIG. 4, an enlarged detail of FIG. 2, but with still another geometry of the valve member and of the valve housing in the flow direction downstream of the valve gap.

### DESCRIPTION OF THE EXEMPLARY EMBODIMENT

The valve 2, shown only partially in the drawing, is part of an injector of a common rail injection system of an internal combustion engine, which serves to inject fuel from a central high-pressure reservoir, known as a common rail, into the combustion chambers of the cylinders of the engine.

The complete structure of such an injector is described at length, for example in German Patent Disclosure DE 196 19 523 A1 of the present Applicant, while further details of the structure of its valve can be found in the aforementioned DE 199 40 296 A1 of the present Applicant; further explanation is therefore dispensed with at this point, and for such explanation, see these references.

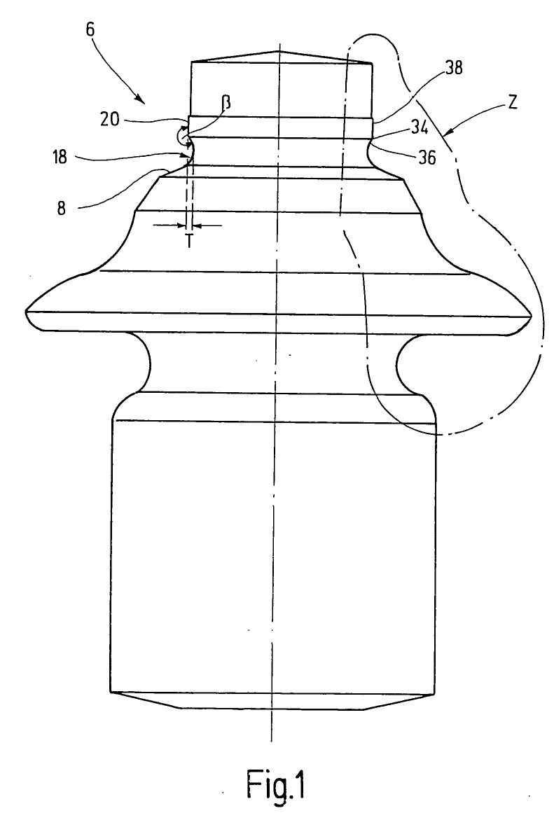

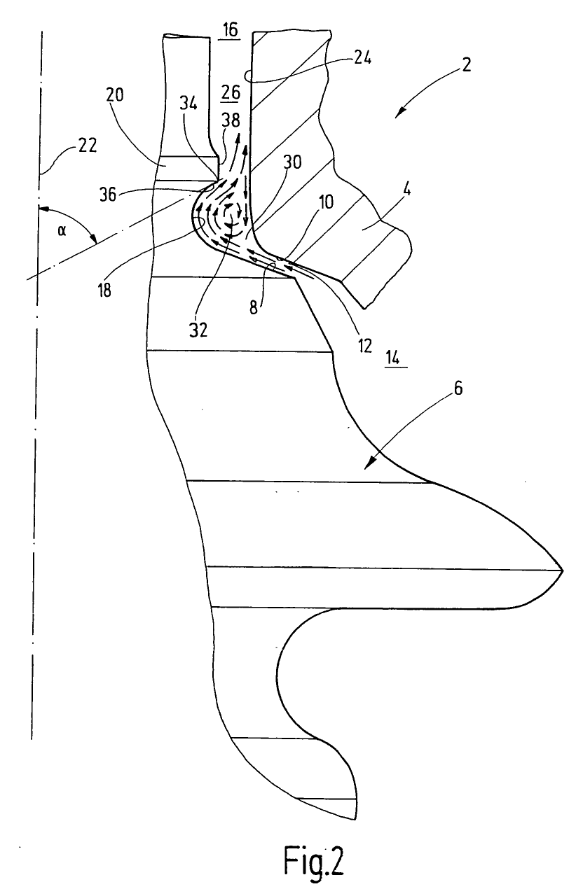

The valve 2 substantially comprises a valve housing 4, into which a rotationally symmetrical valve bolt 6 (see FIG. 1) is inserted axially movably. The valve bolt 6 has a conical sealing face 8, which tapers in the flow direction and which when the valve 2 is closed rests sealingly against a complementary conical valve seat 10 of the housing 4. As best shown in FIGS. 2 through 4, when the valve 2 is open the sealing face 8 together with the valve seat 10 defines a valve gap 12, surrounding the valve bolt 6, in the form of an annular flow conduit, through which the fuel to be injected flows from the high-pressure side 14 of the valve 2 to its low-pressure side 16.

The valve bolt 6 furthermore has an encompassing hollow throat 18, located immediately downstream of the sealing face 8, in its outer circumference, or in other words an indentation or groove of concave longitudinal section, over the axial width of which the diameter of the valve bolt 6 is less than before or downstream of it, where the valve bolt 6 is provided with a cross-sectional thickening 20 that adjoins the hollow throat 18.

The hollow throat 18 serves to deflect at least some of the fuel stream, diverted substantially in the axial direction downstream of the valve seat 10, in such a way that the fuel has a speed component oriented away from a center axis 22 of the valve bolt 6 and, after its emergence from the hollow throat 18, strikes against a diametrically opposed region of the inner wall 24 of an outflow bore 26 of the valve housing 4. As best indicated by arrows in FIGS. 2, 3 and 4,-the fuel stream splits in the process into two partial streams, of which the larger one, after the impact, is directed along the inner wall 24 of the outflow bore 26 into the downstream part of the bore 26, while the smaller stream is deflected back toward the valve gap 12, counter to the flow direction. In the widened annular chamber 30, adjoining the valve gap 12 in the flow direction, between the hollow throat 18 and the diametrically opposed wall region of the inner wall 24, this partial stream together with the fuel stream flowing away from the valve gap 12 forms an eddy 32, which protects the valve housing 4, in the region immediately downstream of the valve seat 10, against erosion caused by cavitation, so that the valve seat 10 remains undamaged even after a long time in operation.

To form this protective eddy 32, the angle of inclination of the fuel stream emerging from the hollow throat 18 relative to the center axis 22 of the valve bolt 6 must not be too small, because otherwise all the fuel will be directed directly into the outflow bore 26. Therefore on the one hand the hollow throat 18 should not be embodied as too flat; instead, it should have a certain minimum depth T (FIG. 1) relative to the adjoining cross-sectional thickening, and this depth, for a diameter of the valve bolt 6 in the middle of the sealing face of 1.35 mm should preferably be greater than 0.04 mm. Second, the hollow throat 18 at the transition to the cross-sectional thickening should not be rounded, since that would also make the angle of inclination of the fuel stream emerging from the hollow throat 18 relative to the center axis 22 smaller as well. Instead, between the hollow throat 18 and the cross-sectional thickening 20, an encompassing edge 34 is provided, at which adjoining outer circumferential surface portions 36, 38 of the hollow throat 18 and of the cross-sectional thickening 20 form a reflex angle 13 (FIG. 1), which should amount to at least 200° and preferably should be between 220° and 240°. Unlike with a rounded transition, at such an edge 34 the flow of the fuel detaches from the circumferential surface of the valve bolt 6, but because of the hardened surface of the valve bolt 6, this does not lead to any cavitation damage. The flow detachment at the edge 34 has the effect that the fuel emerges from the hollow throat 18 at an angle of inclination to the center axis 22 that is substantially equivalent to the angle of inclination a of the circumferential surface portion 36 adjoining the edge 34 inside the hollow throat 18. Depending on how large this angle of inclination is selected to be, upon the impact of the fuel stream with the diametrically opposed region of the inner wall 24 of the outflow bore 26, more or less fuel is deflected back in the direction of the valve gap 12. By means of a suitable choice of this angle of inclination, which is preferably between 20° and 60°, the proportion of reverse-flowing fuel can thus be adjusted to a value such that on the one hand, cavitation damage immediately downstream of the valve seat 10 is prevented by eddy formation, but on the other, the eddy formation does not impair the outflow of fuel after its emergence from the valve gap 12.

In all the exemplary embodiments shown, the fuel flowing in reverse along the inner wall 24 protects the inner wall, to immediately downstream of the valve gap 12, against cavitation-caused damage which could otherwise be caused by a pressure drop in the fuel upon its emergence from the valve gap 12 into the annular chamber 30.

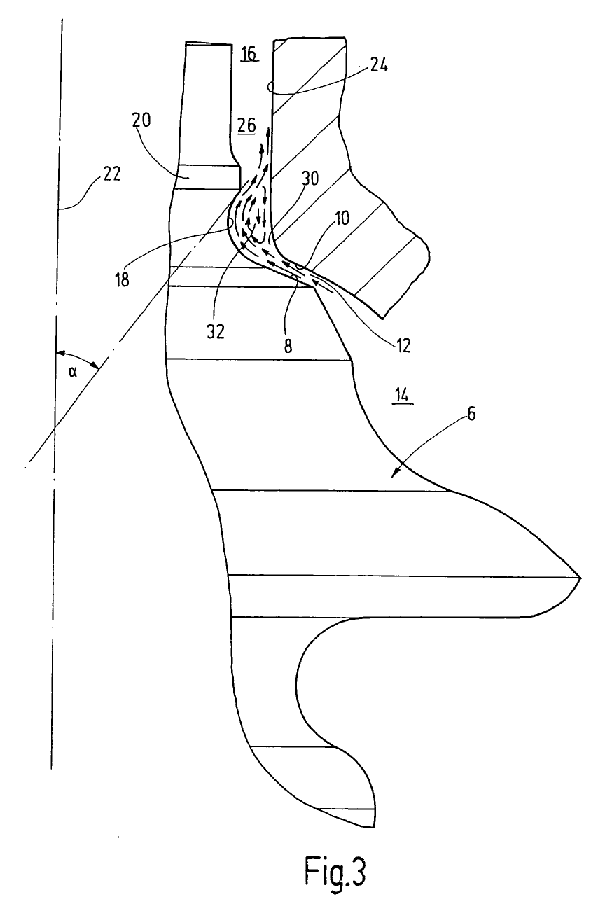

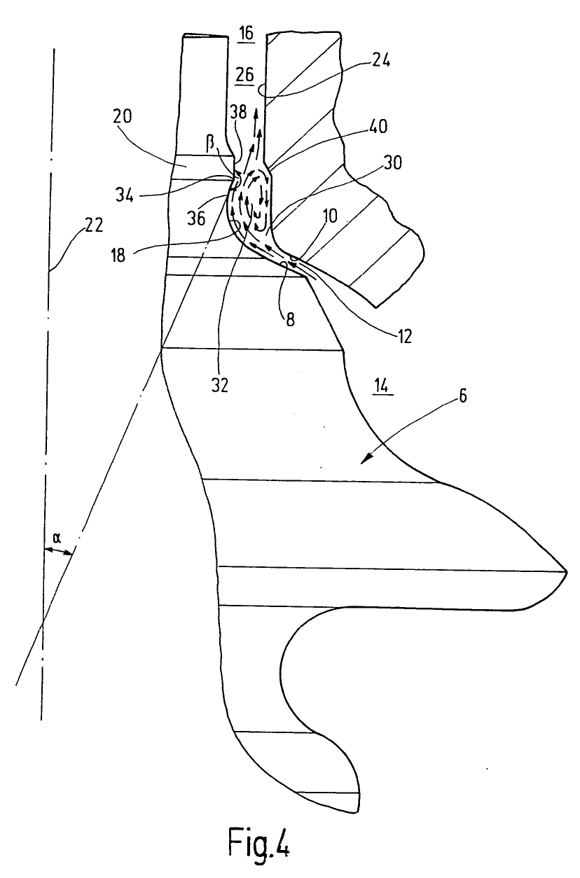

While FIG. 2 shows a valve bolt in which the circumferential surface portion 36, adjoining the edge 34 inside the hollow throat 18, is oriented at an angle of inclination a of approximately 60° to the center axis 22 of the valve bolt 6, and the fuel therefore strikes the inner wall 24 of the outflow bore 26 rather steeply, and thus a relatively large amount of fuel is directed back in the direction of the valve gap 28, FIGS. 3 and 4 show two valve bolts 6 in which this angle of inclination a is approximately 35° and approximately 20°, respectively, and correspondingly less fuel is therefore directed back in the direction of the valve gap 28, forming an eddy 34.

Since the angle of inclination a in FIG. 4 is already within the limit range in which an eddy 34 still forms, the diametrically opposed inner wall 24 of the outflow bore 26 is provided there with a small step 40. This step 40, because of its inclined surface to the center axis 22 of the valve bolt 6 and of the outflow bore 26, promotes the directing of some of the fuel stream back in the direction of the valve gap 12.

The concave boundary of the hollow throat 18 is circular in all the exemplary embodiments; the radius of curvature should not be less than 0.2 mm, in order to enable economical mass production of the valve bolt 6. On its side toward the valve gap 12, the hollow throat 18 merges preferably smoothly with the sealing face 8, as is shown for all the exemplary embodiments.

The sharp detachment edge 34 on the other side of the hollow throat 18, in mass production of the valve bolts 6, can be economically produced by grinding the valve bolt 6 in its final machining down to its final diameter on both sides of the cross-sectional thickening 20, but not in the region of the cross-sectional thickening 20 itself, so that there, the diameter that exist before the final grinding machining of the valve bolt 6 is preserved, thus automatically leading to the formation of the detachment edge 34 at the transition to the hollow throat 18.

1-10. (canceled)

11. A valve for a fuel injection system, the valve comprising
a valve seat embodied in a valve housing,
a valve member movable in the valve housing and having a sealing face that when the valve is closed rests sealingly against the valve seat and when the valve is open, together with the valve seat, defines a valve gap through which fuel flows,
an encompassing hollow throat formed on the valve member and disposed in the flow direction immediately downstream of the sealing face, and
an encompassing cross-sectional thickening of the valve member adjoining the hollow throat.

12. The valve in accordance with claim 11, further comprising an encompassing edge between the hollow throat and the cross-sectional thickening, at which edge the outer circumferential surface portions of the hollow throat and of the cross-sectional thickening adjoin one another and meet at an angle.

13. The valve in accordance with claim 12, wherein the circumferential surface portions of the valve member meet at the edge at a reflex angle.

14. The valve in accordance with claim 12, wherein the outer circumferential surface portion adjoining the edge on the side toward the cross-sectional thickening, is oriented essentially parallel to a center axis of the valve member.

15. The valve in accordance with claim 13, wherein the outer circumferential surface portion adjoining the edge on the side toward the cross-sectional thickening, is oriented essentially parallel to a center axis of the valve member.

16. The valve in accordance with claim 12, wherein the circumferential surface portion adjoining the edge on the side toward the hollow throat, is inclined at an angle of between 20° and 60° relative to a center axis of the valve member.

17. The valve in accordance with claim 14, wherein the circumferential surface portion adjoining the edge on the side toward the hollow throat, is inclined at an angle of between 20° and 60° relative to a center axis of the valve member.

18. The valve in accordance with claim 11, wherein a radius of curvature of the hollow throat is greater than 0.2 mm.

19. The valve in accordance with claim 12, wherein a radius of curvature of the hollow throat is greater than 0.2 mm.

20. The valve in accordance with claim 13, wherein a radius of curvature of the hollow throat is greater than 0.2 mm.

21. The valve in accordance with claim 14, wherein a radius of curvature of the hollow throat is greater than 0.2 mm.

22. The valve in accordance with claim 16, wherein a radius of curvature of the hollow throat is greater than 0.2 mm.

23. The valve in accordance with claim 11, wherein the hollow throat and the sealing face merge smoothly with one another.

24. The valve in accordance with claim 13, wherein the hollow throat and the sealing face merge smoothly with one another.

25. The valve in accordance with claim 14, wherein the hollow throat and the sealing face merge smoothly with one another.

26. The valve in accordance with claim 16, wherein the hollow throat and the sealing face merge smoothly with one another.

27. The valve in accordance with claim 11, wherein the cross section of the valve member tapers downstream of the cross-sectional thickening in terms the flow direction.

28. The valve in accordance with claim 12, wherein the cross section of the valve member tapers downstream of the cross-sectional thickening in terms the flow direction.

29. The valve in accordance with claim 11, wherein an outer circumferential surface of the valve member is ground down, at least in the region of the sealing face and of the hollow throat, but not in the region of the cross-sectional thickening.

30. A fuel injection pump, comprising by a valve in accordance with claim 11.
